(19) United States
(12) Patent Application Publication
(10) Pub. No.: US 2014/0375684 A1
(43) Pub. Date: Dec. 25, 2014

(54) Augmented Reality Technology

(71) Applicant: Cherif Algreatly, Newark, CA (US)

(72) Inventor: Cherif Algreatly, Newark, CA (US)

(73) Assignee: Cherif Atia Algreatly, Newark, CA (US)

(21) Appl. No.: 14/181,726

(22) Filed: Feb. 17, 2014

Related U.S. Application Data
(60) Provisional application No. 61/765,798, filed on Feb. 17, 2013.

(51) Int. Cl. G06T 19/00; G06T 7/00

(52) U.S. Cl. CPC G06T 19/006; G06T 7/0085; G06T 2207/10004; G06T 2207/20136; G06T 2207/30244
USPC 345/633

(57) ABSTRACT

A method is disclosed for determining the user's position by analyzing a picture of buildings located in front of the user and comparing the picture content with a database that stores a 3D model of the buildings. The method is utilized in various indoors and outdoors augmented reality applications. For example, the method gives the user accurate directional instructions to move from a place to another. It enables the user to accurately tag parts of buildings or places with virtual digital data. Also, the method allows the user to augment parts of buildings or places with certain Internet content in a fast and simple manner.

### CROSS-REFERENCE TO RELATED APPLICATION

This application claims the benefits of a U.S. Provisional Patent Application No. 61/765,798, filed Feb. 17, 2013, titled “System and Method for Augmented Reality”.

### BACKGROUND

The three main technologies that serve augmented reality are global positioning system (GPS), markers, and indoor positioning system (IPS). Each one of these three technologies has its own limitation and disadvantages. For example, GPS satellite signals are weak, comparable to the strength of cellular phone signals, and so it does not function inside buildings, especially away from the buildings opening. High GPS accuracy requires a line-of-sight from the receiver to the satellite; accordingly the GPS does not work well in an urban environment, or under trees. Even in the best situation, the GPS is not very accurate in detecting the user's exact position when used outdoors, which is critical for the use of augmented reality technology.

The main disadvantage of using markers, as a system for position recognition, is its need for pre-preparation in each position the augmented reality will be running, which is a needless consumption of time and energy. If one of the markers is lost or moved away from its position, the augmented reality application will not work. If someone or some object is moved or relocated between the makers and the camera that tracks the markers, the augmented reality application stops immediately. These disadvantages limit the use of markers in augmented reality applications, especially for unprofessional users.

The IPS is a network of devices used to wirelessly locate objects or people inside a building. It relies on nearby anchors or nodes with a known position, which either actively locate tags or provide environmental context for devices accessible to users. The main disadvantages of the IPS are the high cost of the system, as well as, the time and effort spent in initiating the system. Counting on multiple hardware devices that are located at certain positions inside the building is not a simple approach. If there is a problem with the hardware, then it requires replacing or fixing the hardware, which stops the augmented reality application for a time.

Frankly, there is a vital need for a new type of augmented reality technology that works indoor and outdoor, without limitation or constrain. This new technology should achieve high accuracy in detecting the user's position and also that of the buildings or objects located around the user. Also, the new technology should require no preparation from the user's end to run the augmented reality applications. Essentially, this new technology should save the user valuable time and effort, while also reducing the cost attached with using augmented reality applications.

### SUMMARY

The present invention introduces a new technology for augmented reality that does not utilize GPS, markers, or IPS. This new technology overcomes the aforementioned disadvantages of the GPS, markers, and IPS technologies. For example, the present invention operates indoors and outdoors, providing maximum accuracy in detecting the user's position and the location of real-world environments; those elements can be implemented clearly in the augmented reality application. The present invention requires no preparation from the user to view the application, or any special hardware or the like. Moreover, the main advantage of the present invention is utilizing an existing hardware technology that is simple and straightforward and which easily and inexpensively carries out the functions of the present augmented reality technology.

In one embodiment, the present invention discloses a method for determining the position of a camera relative to buildings located in front of the camera. The method captures the picture of the buildings and compares the edges of these buildings with a database that stores a 3D model of the buildings. As a result, the position of the camera is determined, as well as, the location of the buildings or objects located in front of the camera. At this moment, the augmented reality application is running on a display according to the determined positions of the camera and buildings. Once the camera is rotated or moved from its location, the pictures of the buildings change, and the process is restarted again to determine the new positions of the camera and the buildings. The augmented reality application is then adjusted to suit the new position of the camera.

In another embodiment, the present invention utilizes a tracking unit that tracks the movement or rotation of the camera relative to a start position. The camera movement or rotation is then re-considered to determine the new location and direction of the camera and any new buildings that appear in the camera picture. At this moment, the augmented reality application effectively adjusts to suit the new position of the camera, without comparing the picture content with a database. Once the content of the camera picture is compared with the database at a start position, tracking the new movement or rotation of the camera is enough to determine the new camera position relative to the start position. Accordingly, the need for comparing the picture's content with the database of 3D models of the building is done once, at the start of the process.

The potential uses of the present invention are virtually unlimited. For example, the present invention can be utilized to navigate the user from place to place whether indoor or outdoor. It can be used to allow a user to tag places with annotations, and the user's tags or annotations can be visible to other users who also view these places via a camera display. It can be employed to determine the part of a scene that a camera is aiming towards, even if this scene has no buildings or distinguished objects such as rivers, lakes, mountains, or green areas. Also, the present invention can be utilized as an additional tool with the GPS to accurately confirm the user's position when such precise tracking of the user's position is needed. All this is in addition to various other viable applications to be described subsequently.

It is important to note that the above Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a block diagram for the main components of the present invention according to one embodiment.

FIG. 2 illustrates a camera's position where two projected lines are presented on its display as a result of two real lines located in front of the camera.

FIGS. 3 to 5 illustrate three examples of two real lines that lead to the same two projected lines on the camera's display.

FIG. 6 shows a table of assumptions representing the potential intersections between the two real lines, and three rays that are extending from the viewpoint of the camera.

FIG. 7 illustrates four positions of viewpoints of a camera capturing pictures of a square that looks similar from each position.

FIG. 8 illustrates a circle positioned near the square that allows each of the four viewpoints or positions of the camera to capture a different picture.

FIG. 9 illustrates a plurality of 3D objects that appears differently in each picture taken by a camera from a different position or viewpoint.

FIG. 10 illustrates a camera display presenting a picture of buildings located in front of the camera.

FIG. 11 illustrates a window of an augmented reality application drawn by a user on a building to display a picture, video, or annotation inside the window.

FIG. 12 illustrates a menu that appears when drawing the window to enable the user to select the content of the window.

FIG. 13 illustrates another method for locating a window in an augmented reality application by providing the dimensions of the window and its distance from a building.

FIG. 14 illustrates an arrow drawn on a building ceiling in an augmented reality application to give directional instructions to a user.

### DETAILED DESCRIPTION

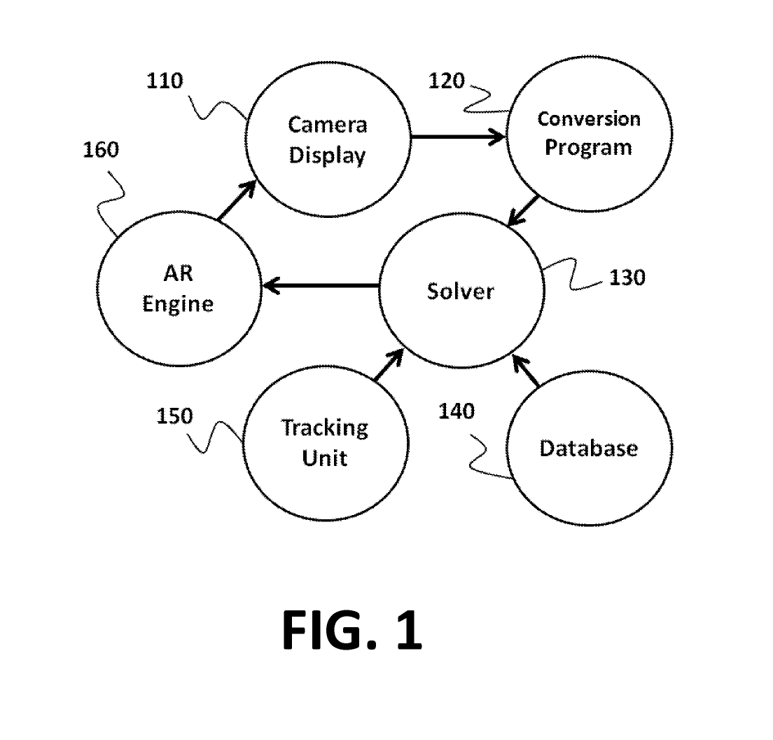

FIG. 1 illustrates the main components of the present invention, according to one embodiment. As shown in the figure, the system of the present invention is comprised of a camera display 110, a conversion program 120, a solver 130, a database 140, a tracking unit 150, and an augmented reality (AR) engine 160.

The camera display is the display of a digital camera that presents the buildings or walls in front of the camera lens. The conversion program utilizes an edge detection technique that defines the edges of the buildings or walls presented on the camera display and sends this data to the solver. The solver is a CPU equipped with a software program that receives the data of the edges from the conversion program and accesses the database to calculate the position and the 3D angle of the camera. The database stores data representing the edges of the 3D models of the buildings or walls around the camera. The CPU compares the data of the edges presented on the camera display with similar data stored in the database to determine the position and the 3D angle of the camera. Once the position and the 3D angle of the camera are determined, the tracking unit detects the change of the camera's position and 3D angle, when the camera is moved or rotated, and sends this information to the solver. The camera's new position and 3D angle are then determined by the solver. The augmented reality engine receives the current position and 3D angle of the camera from the solver and presents the digital data of the augmented reality application on a display according to each current position and 3D angle of the camera.

The camera can be a camera of a mobile phone, tablet, or head mounted computer display (HMD) in the form of eye glasses. The screen of the mobile phone or tablet, or the eye glasses of the HMD, can be utilized to present the building or walls in front of the camera. The conversion program functions on the mobile phone, tablet, or head mounted computer to analyze the edges of the buildings or walls presented on the screen in real time. The output of the analyses is a plurality of lines where each line is described with a start point and an end point. The database stores the 3D models of the buildings and walls where the augmented reality will be running. For example, when using the present invention in a mall or school, the 3D models of the buildings of the mall or the school are stored in the database. The 3D models only include the edges or borders of each building or wall in the mall or school with their dimensions. Other information such as the colors or the materials of the surfaces of the buildings or walls does not need to be stored in the database.

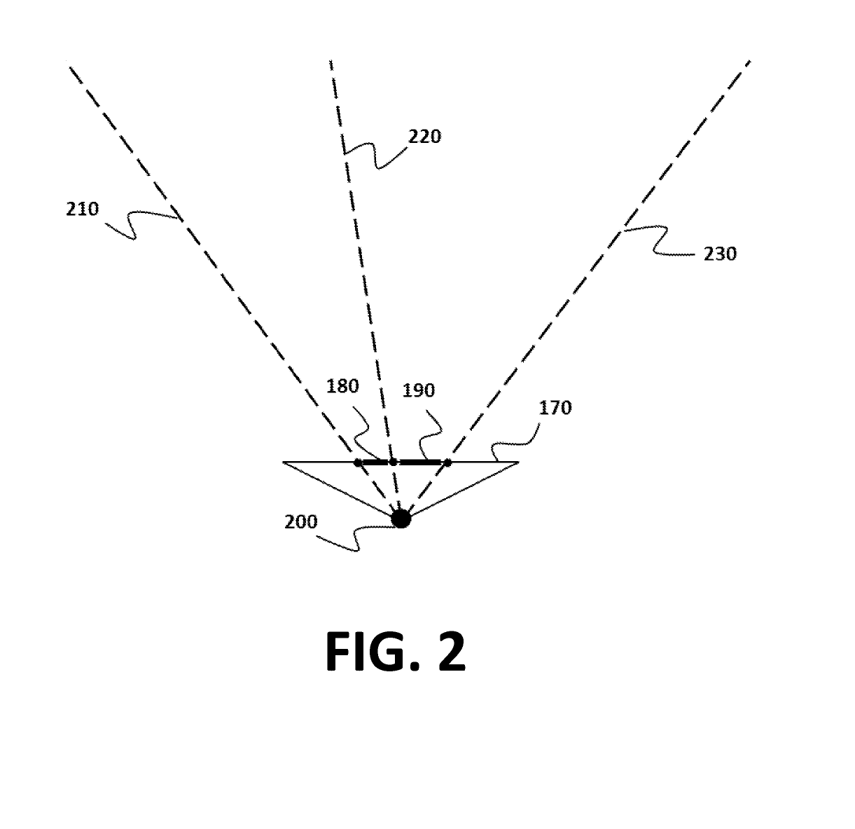

The solver compares the edges or lines received from the conversion program with the edges or lines stored in the database to determine the position and 3D angle of the camera. To clarify this process or technique, FIG. 2 illustrates a display 170 of a camera presenting a first projected line 180 and a second projected line 190. Both of the first projected line and the second projected line are horizontal lines, and are a result of two real lines located in front of the camera. The viewpoint 200 represents the position of the eye when seeing real lines in front of the camera's lens. Each one of the first projected line and the second projected line has a start point and an end point. The first ray 210, the second ray 220, and the third ray 230 represent three rays that are extending from the viewpoint to pass through the start and end points of the first and second projected lines on the display.

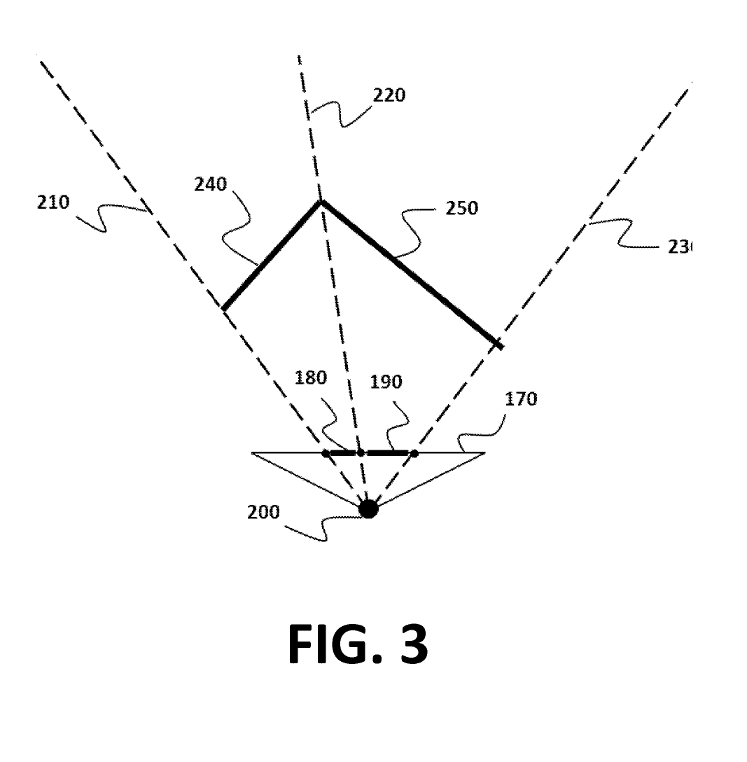

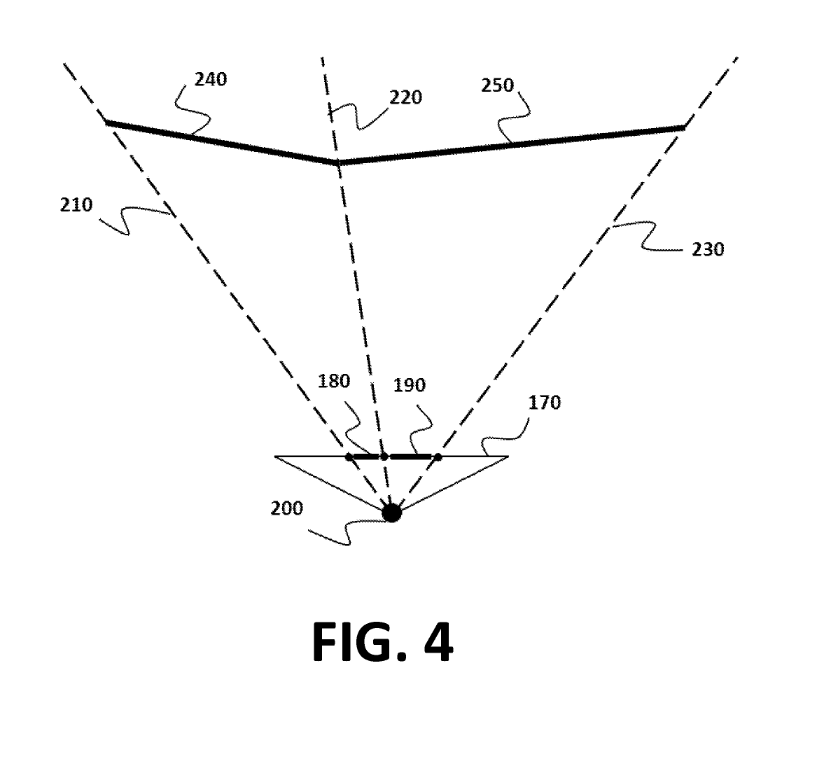

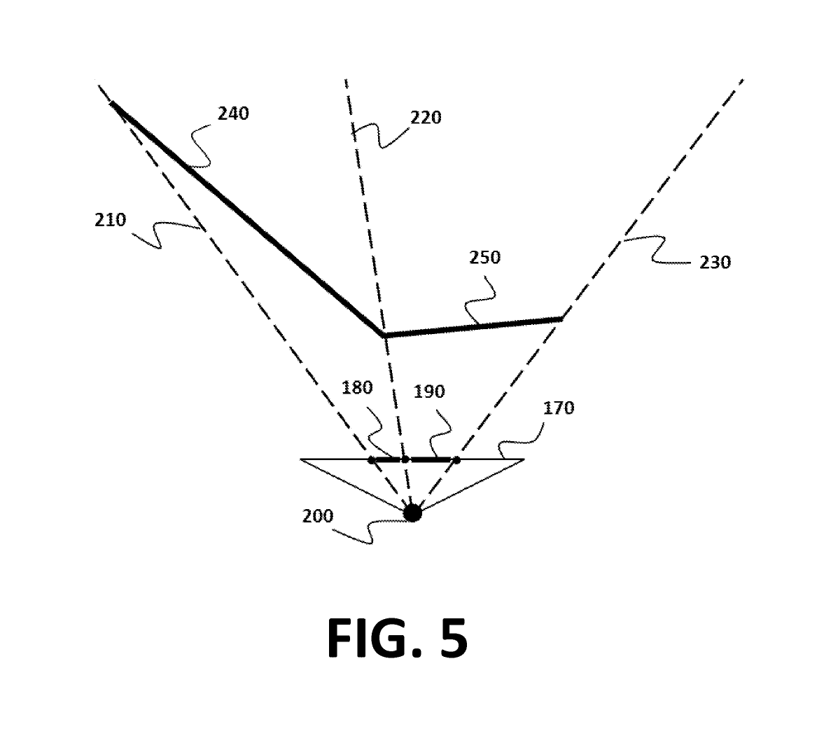

To determine the positions of the real lines using the two projected lines, the solver performs certain calculations. FIGS. 3 to 5 illustrate three imaginary cases with a first real line 240 and a second real line 250 that can be projected on the display to form the same first projected line and the same second projected line of FIG. 2. These three imaginary cases are only samples of many cases that lead to creating the same first and second projected lines on the display. To determine the actual case of these many cases, the equations of intersection between the first ray 210, the second ray 220, and the third ray 230 with the first real line 240 and the second real line 250 are solved to determine the points of intersection. This is based on the assumption that the 3D models of the first and second real lines are stored in the database.

Assuming that the coordinates of the viewpoint are “x” and “y”, then the coordinates of each start point and end point of a projected line on the display can be described relative to “x” and “y”. This is based on the locations of each start and end point of the projected lines are known, as well as, the distance between the viewpoint and the center of the display. Accordingly, the equation of the first ray, second ray, and third ray can be defined relative to the “x” and “y”. Also, the equations of the first real line and second real line can be defined by using the point coordinates of each real line stored in the database. Solving the equations of intersections between the first ray, second ray, and third ray with the first and second real lines determines the values of “x” and “y”.

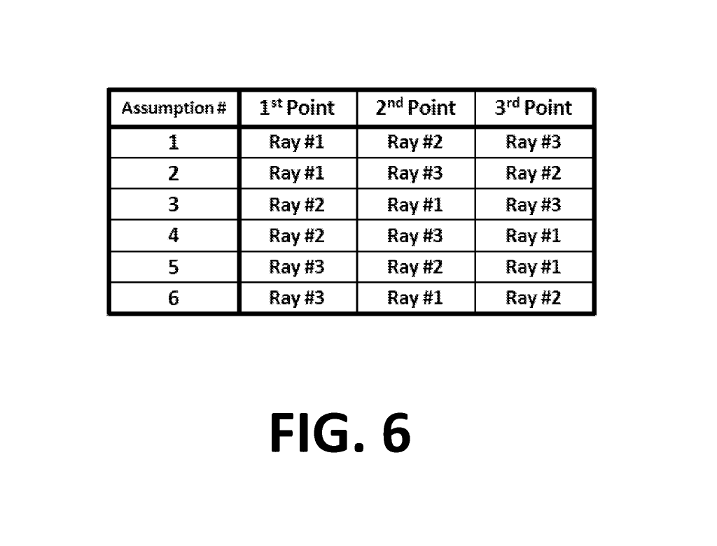

To solve the equations of intersections between the lines, a table of assumptions such as the one shown in FIG. 6 is used. This table represents the potential intersections between the two real lines and the three rays. The two real lines can be described with a first point, a second point, and a third point representing their start and end points. As shown in the table, there are 6 alternatives of intersections. For example, alternatives No. 1 assumes that the first real line is intersecting with first and second rays, and the second real line is intersecting with the second and third rays. However, it is important to note that in this assumptions table, each of the first and second real lines can not overlap with one of the three rays otherwise one of the two real lines wouldn't be projected with a start point and end point on the display.

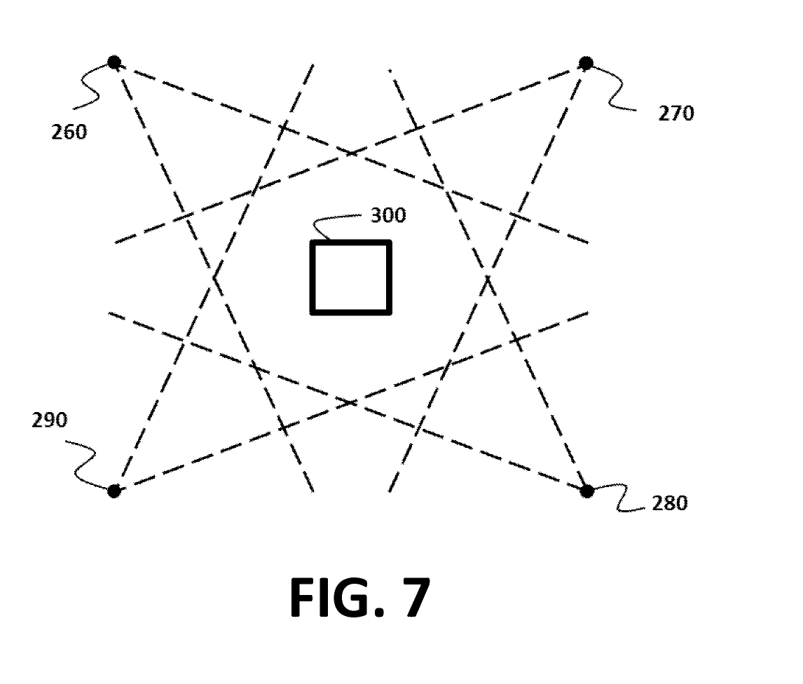

Solving the equations of the intersections based on the assumptions table leads to calculating the values of “x” and “y” of the viewpoint which determines the position of the camera. However, it is possible to find more than one value for the “x” and “y” of the viewpoints. For example, FIG. 7 illustrates four positions of viewpoints 260 to 290 of a camera capturing a picture of a square 300 where the lines of the square will be projected on the camera display to look similar from each one of the four positions. In such a case, solving the equations of the real lines and the rays leads to four values for the “x” and “y” of the viewpoint which represents four different positions for the camera.

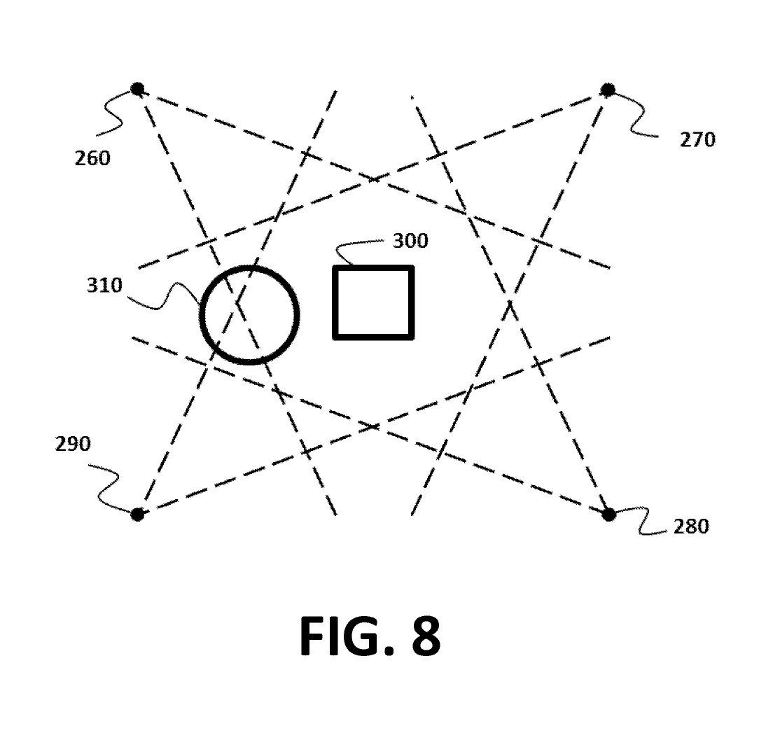

FIG. 8 illustrates adding a circle near the square, where in this case, each position of the four viewpoints will view different combination of lines of the square and the circle, considering that the circle can be represented by a plurality of lines. In other words, capturing the picture of multiple objects creates different projection lines at each different position of a viewpoint, which enables determining the location of the viewpoint of the camera. In fact, in real life most pictures will contain multiple objects that enable the present invention to determine the position of the camera. This is similar to the way a human can figure out the position of the camera when seeing a picture taken from inside a place s/he knows such as his/her home or office. If there are multiple locations that are similar, in this case, the human cannot figure out the exact camera position if s/he saw a picture of one of these similar locations.

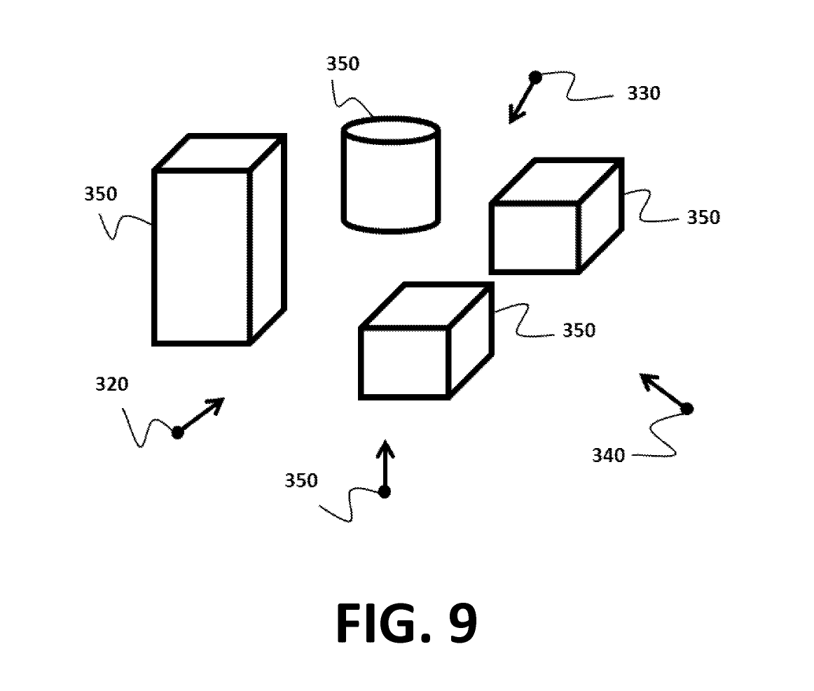

Generally, the previous examples illustrate the projection of 2D lines on a camera display, while FIG. 9 illustrates an example for 3D objects. As shown in the figure, four positions 320 to 350 represent four viewpoints of a camera capturing a picture of a plurality of 3D objects 350, in the form of two cubes, cylinder, and prism. In this case, the picture of each different viewpoint will includes different lines or edges representing different scenes of the 3D objects. Comparing the lines or edges that appear in each picture with a database of the 3D model of the 3D objects determines the position and 3D angle of the camera relative to the location of the 3D objects. Determining the position and 3D direction of the camera relative to the locations of the 3D objects enables running an augmented reality application on a display to accurately overlay the pictures taken by the camera.

Once the user moves the camera to view different parts of the 3D objects or to view a certain part of the augmented reality application, in this case, the conversion program analyzes the new edges of the 3D objects that appear in the new picture and sends this data to the solver. At this moment, the solver determines the new position of the camera relative to the 3D objects, which adjusts the content of the augmented reality application accordingly.

In another embodiment of the present invention, the tracking unit detects the movement and/or tilting of the camera and sends this data to the solver. In this case, the solver determines the new position and 3D angle of the camera without the need to analyze the edges or lines presented in the pictures of the camera. The tracking unit can be comprised of an accelerometer and 3D compus to detect the movement and the horizontal and vertical rotations of the camera. Accordingly, any device equipped with a camera, display, accelerometer, 3D compus, and CPU, such as a mobile phone, tablet, or head mounted computer display in the form of eye glasses, can utilize the present invention.

In another embodiment, the solver may find multiple locations in the database that match the picture content of the camera. In this case, the camera is partially rotated horizontally or vertically and returned to its start position to capture the pictures of the surroundings located around the content of the first picture. This type of partial rotation can be done automatically. However, the solver analyzes the picture of the surroundings to determine which one of the multiple locations in the database matches the first picture of the start position of the camera.

If the partial rotation of the camera is not enough for the solver to determine the position of the camera, in this case, the user may be requested to completely rotate the camera 360 degrees. If the 360 degree rotation is not enough for the solver to determine the camera position, the user may be requested to move from his/her position to a position known to the solver, and then return back to the original position. In this case, once the solver detects the camera position at the known position, the tracking unit tracks the user's movement in his/her way back to the start position. The tracking unit provides the solver with data representing the location of the start position of the camera relative to the known position. This data enables the solver to determine the position of the camera at the start position, and accurately run the augmented reality application.

In one embodiment of the present invention, each unique configuration of edges or lines is associated with a certain augmented reality content. In this case, determining the location of the camera relative to the buildings stored in the database is not important. In fact, determining the location of the camera relative to the unique configuration of the edges or lines is more important to present certain content of augmented reality on top of these edges or lines. For example, when presenting the same augmented reality content on all faces of a cube, in this case, it does not matter which face of the cube the camera is taking a picture of. Also, when presenting certain augmented reality content on all openings of a building, in this case, the location of the camera inside the building does not matter as long as the camera picture indicated lines or edges of an opening.

Generally, determining the position of a camera using the present invention opens the door for innovative software applications which can be very helpful for users and society. The followings are examples of ten such viable applications, out of many applications, that can utilize the present invention.

The first application is detecting the user's location indoors, such as inside malls or hotels, and giving the user directional information to go from place to place. This is achieved in three steps. The first step is taking a picture, for example by the user's mobile phone, to enable the present invention to determine the user's location. The second step is presenting pictures of different places inside a location from which the user may select the picture of a place s/he would like to go to it. These pictures can be for the main entrance of a restaurant, or the like. The third step is presenting an augmented reality application that gives the user the direction to move from his/her position to the new place s/he selected. The augmented reality application can be in the form of an arrow that overlays the picture displayed on a mobile phone screen to direct the user's movement.

A second application can enable a user to tag different places, indoor or outdoor, with comments that can be visible to others who visit the same place. For example a user can capture a picture of a restaurant entrance by his/her mobile phone and start typing on a special program any comments s/he would like to tag to the restaurant entrance. Once the user does that, anyone who uses a mobile phone camera to take a picture, or look using a mobile phone camera at the same restaurant will be able to view the comments of the first user. All users can add comments or tag the same restaurant entrance with any information they wish. Such an application provides the user with instant information regarding the places they are visiting from other user who previously visited the same place.

A third application can be enabling a user to post a message or comment regarding a certain place to be viewed by a specific user. For instance, a parent may use a mobile phone camera to capture his/her home and then compose a message for his/her kids to appear in front of the home. The message will only be visible to the parent's kids via detection of the IDs associated with their mobile phones. Once the kids use their mobile phone camera to view the home, the message will appear to them in front of the home. Any other device or mobile phone cannot view the massage since their devices or mobile phone IDs are not authorized to view the massage. The parent's massage can be restricted to appear at specific times during the day or the week, or in certain weathers or circumstance.

A fourth application can be enabling an administrator to edit an augmented reality application for a building using the 3D model of the building. This is achieved by a software program that presents a 3D model of the building with some editing tools where an administrator can position a text, picture, or video on a certain location of the 3D model of the building. Once a user uses a camera of a device to view this certain location, then the text, picture, or video positioned by the administrator is visible to the user as an augmented reality application on the device display. For example, the building can be a mall, the certain location can a specific store of the mall, and the administrator can be the owner of the stores. The text, picture, or video can be information or advertisements related to the store. Of course, there can be multiple administrators. For example, the owner of each store in a mall can be an administrator of the 3D model of his/her store to control the augmented reality applications that appear on his/her store walls.

A fifth application can be associating each unique place of a list of places with unique content of an augmented reality application, where these place are not located in one location. For example, a 3D model can be stored in a database for the top 100 restaurants in a city. In this case, the 3D model can include the entrances of each one of the 100 restaurants. Once a user is viewing a restaurant entrance of the 100 entrances by their device, the augmented reality application starts presenting information or content related to this specific restaurant on the device display. The advantage of this application is easing the creation of the database so that it will only include the relevant buildings or certain sections of the buildings that the user may be interested in.

A sixth application can be made to determine the sight of line of a camera when viewing a scene that includes no buildings. This is achieved by identifying the position and 3D direction of the camera at the last buildings viewed by the camera then tracking the camera rotation and movement to determine the line of sight of the camera. For example, in the case of determining which part of a mountain a camera is viewing at a moment. In this case, it is hard to compare the outlines of the mountain with any 3D model of the mountain. However, determining the position and 3D direction of the camera when viewing the last buildings that are included in the database, and tracking the camera movement and rotation after that enables determining the final sight line of the camera. Finding the intersection between the final sight line of the camera and the 3D model of the mountain enables determining which part of the mountain the camera is aimed towards. The same concept can be used with other scenes that do not include buildings such as rivers, lakes, green areas, or the like.

The seven application can be linking an augmented reality application with interne content. For example, a user can tag a part of a building with a window described by the URL of a video. Once anyone views this part of the building with a camera of a device, the video is then presented on the device display as an augmented reality application. The user can change the video to a new video at any time, where the new video is presented on the part of the building, as an augmented reality application, once it is viewed by a camera display.

The eight application can be linking an augmented reality application with an internet result of a search keyword. For example, a user can define a window for an augmented reality application on a part of a building and associate this window with a search keyword and an internet search engine. For example, a window specified on a wall of a room and this window is specified by the word “love” as a search keyword, “GOOGLE SEARCH” as a search engine, and “video” as a search type. Once a user views this room wall with a camera display the windows presents the first video of the search results of GOOGLE using the keyword “love”. Of course, the result of the search may vary from time to other, where the window always presents the first result of the search engine regardless of its outcome. Of course, the search type can be a picture, news, article, maps, or any search choice available on the Internet.

The ninth application is creating an augmented reality application related to a plurality of object without a need to manually build the 3D model of the objects. This is achieved by rotating the camera vertically and horizontally to capture all possible pictures of the object. Each picture is analyzed to determine the lines of its object's edges. The user can associate and store a certain picture or view of these objects with a window of an augmented reality application containing video, picture, or the like. Once a camera is moved around the plurality of objects to view the same certain picture on its display, then the window of the augmented reality application is presented on the camera display. This method saves the user's time and efforts in building the 3D model of the objects.

The tenth application can he confirming the exact position of a GPS. For example, using a device such as a mobile phone equipped with a GPS and camera can help the GPS system define the exact position of the GPS. In this case, the user's position which is indicated by the GPS will help the database search the 3D models in a specific zone, where the search results will indicate the exact position of the user in this specific zone. Of course, the search of the database is based on the picture of the buildings taken by the camera at the user's position, as was described previously. This method dramatically speeds up the search of the database. However, using the GPS as an additional tool to the present invention can speed up the search of the database, especially when dealing with a large area or many buildings.

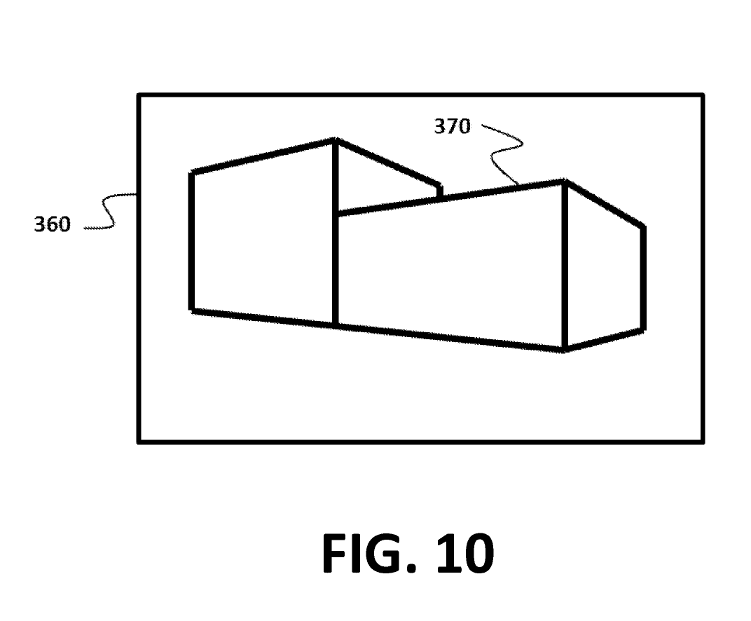

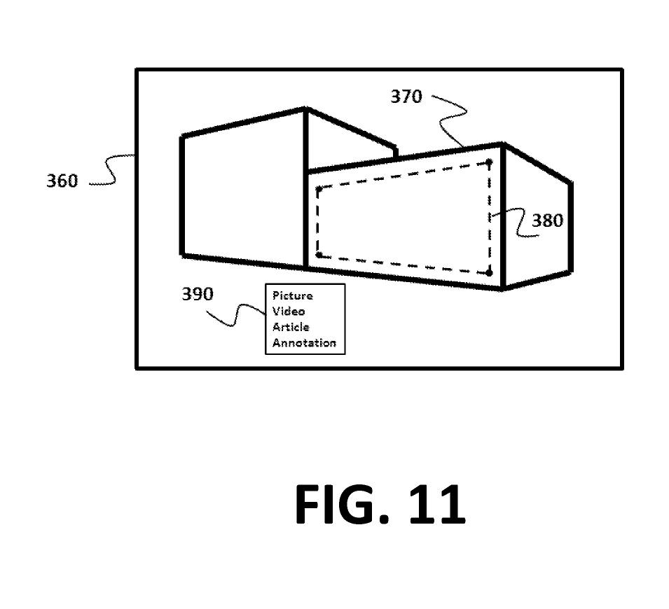

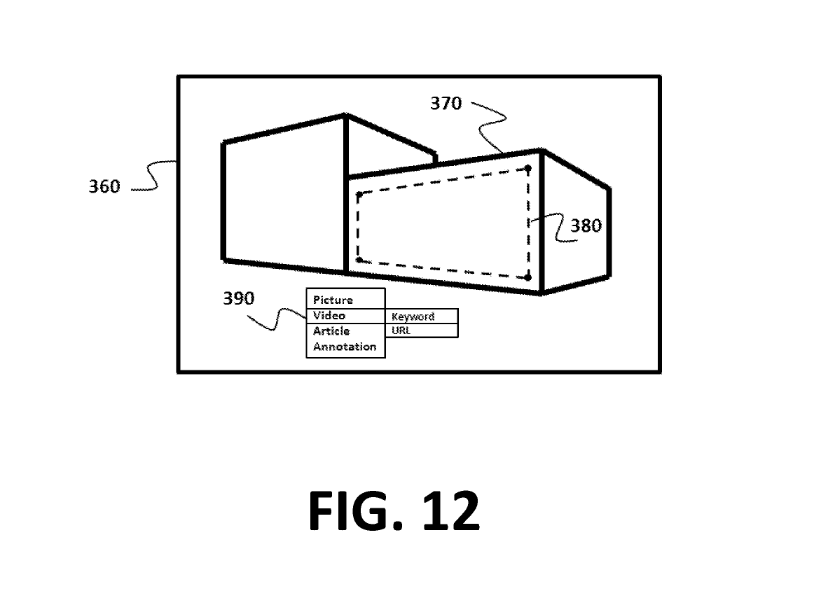

FIG. 10 illustrates a display 360 of a camera where some buildings 370 appear on this display. In FIG. 11, a user draws a window 380 on one of these building, where a menu 390 appears to the user on the display to select the content of this window. As shown in the figure, the menu elements are picture, video, article, and annotation. In FIG. 12, the user selected the “video” option from the menu, where a sub menu appears to give the user the choice of getting the video by using a search keyword or a URL. If the user entered a keyword then the augmented reality engine utilizes the keyword to retrieve a video from an Internet search engine using this search keyword. If the user selected the URL option, then s/he needs to provide this URL of the video to the software program as was described previously. The “annotation” option in the menu opens a text window to the user to type in it, where this annotation appears on the window immediately as an augmented reality application.

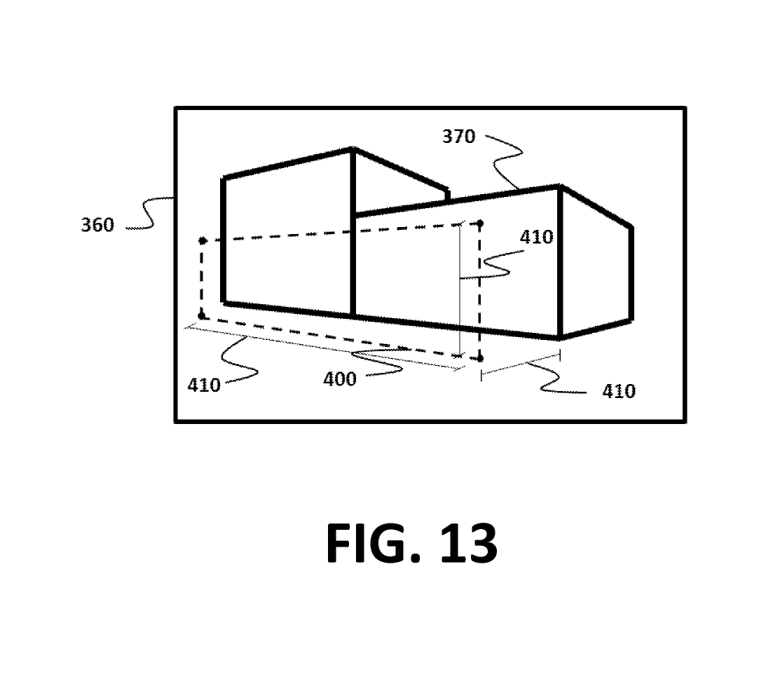

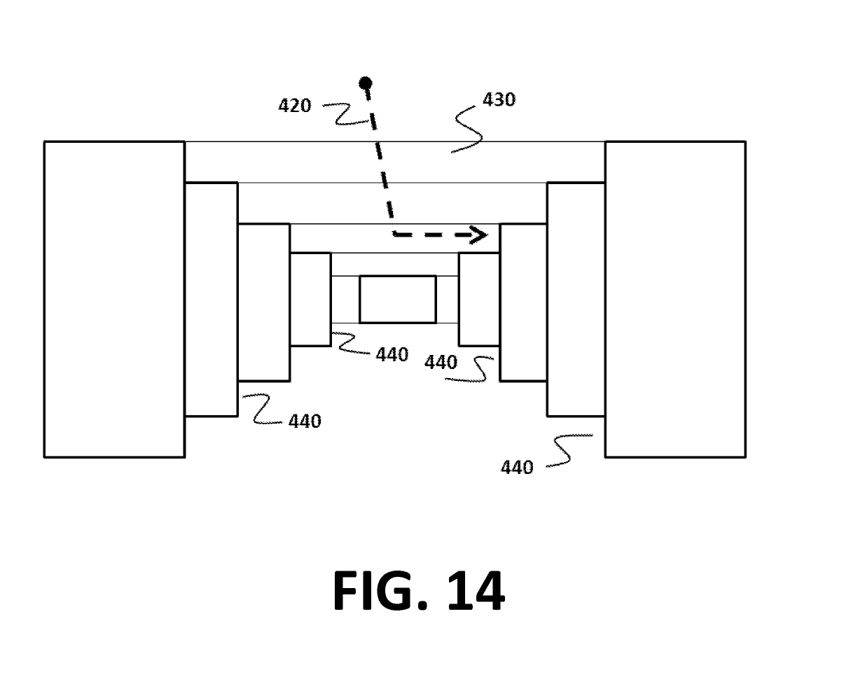

FIG. 13 illustrates another manner of specifying the location of the window 400 of the augmented reality application. In this case the user relates the location of the window to a building by a set of distances or dimensions. As shown in the figure, the width and height, as well as, the distances between the window and the building are given certain dimensions by the user. Finally, FIG. 14 illustrates an example of an augmented reality application used in a store to help users locate certain products. As shown in the figure, a path 420, in the form of a directional arrow, appears on a device display to overlay with the ceiling 430 of the store. The different aisles 440 of the store are not utilized with the directional arrow since people moving in front of the camera may hide the aisles. This directional arrow is opposite to the ceiling, which is always clear from any obstacles when viewed by a camera display. Generally, using the directional arrow with the ceiling is a practical solution for busy places such as busy stores, exhibitions, hotels, or the like.

The main advantages of the present invention is utilizing an existing hardware technology that is simple and straightforward which easily and inexpensively carries out the present 3D force sensors. For example, in FIG. 1, the camera display can be a display of an electronic device such as a mobile phone, tablet, or GOOGLE GLASS. The conversion program is a software program for edge detection, as known in the art. The solver is the computer system of the electronic device. The database can be a preset database of 3D models such as GOOGLE EARTH, or a database of 3D models created especially for certain buildings. The tracking unit, as was described previously, is a combination of accelerometer and 3D compus. The AR engine is the software program for the augmented reality application running on the device display. It changes the view of the augmented reality according to the change of the position or rotation of the camera as used in common augmented reality applications. The change of the position or rotation of the camera is detected by the tracking unit, or by the analyses of the picture presented on the camera display, as was described previously.

Overall, as discussed above, an augmented reality technology is disclosed, while a number of exemplary aspects and embodiments have been discussed above, those skilled in the art will recognize certain modifications, permutations, additions and sub-combinations thereof. It is therefore intended that claims hereafter introduced are interpreted to include all such modifications, permutations, additions and sub-combinations as are within their true spirit and scope.

1. A method for augmented reality comprising;
detecting a plurality of lines representing the edges of objects relative to a viewpoint;
comparing the plurality of lines with a database that stores the 3D model of the objects to determine the position of the viewpoint relative to the objects; and
running an augmented reality application on a display to overlay the image of the 3D objects relative to the position of the viewpoint.

2. The method of claim 1 wherein the detecting is achieved by an edge detection program.

3. The method of claim 1 wherein the edges are extracted from a picture taken at the viewpoint.

4. The method of claim 1 wherein the database stores the edges of the 3D models.

5. The method of claim 1 further the movement and rotation of the viewpoint is detected by a tracking unit to determine the current position and 3D direction of the viewpoint relative to a start position and a start 3D direction.

6. The method of claim 1 further the viewpoint is rotated or moved to detect a plurality of lines that leads to determining the exact position of the viewpoint at the start location.

7. The method of claim 1 further the database is automatically created by capturing the picture of the objects from different positions by a camera and storing the edges that appear in each picture associated with a camera position.

8. The method of claim 1 further the augmented reality application provides directional instructions of a movement from a place to another.

9. The method of claim 1 further the augmented reality application enables a user to tag a part of the objects with an annotation that appears to a specific user or appears to users of the augmented reality application.

10. The method of claim 1 further the augmented reality application associates a part of the objects to a specific administrator that can tag the part with an annotation that appears to users of the augmented reality application.

11. The method of claim 1 further the augmented reality application associates each unique place of a list of places with a unique content.

12. The method of claim 1 further the augmented reality application determines the line of sight of a camera when picturing a scene that includes no buildings or distinguished objects.

13. The method of claim 1 further the augmented reality application presents a virtual window containing a picture, video, or content described by a URL.

14. The method of claim 1 further the augmented reality application presents a virtual window containing a search result of a search keyword provided by a user.

15. The method of claim 1 further the augmented reality application enables the user to determine the location or dimensions of a virtual window that includes the content of the augmented reality application.

16. The method of claim 1 further the content of the augmented reality application is presented on a picture of a ceiling of a building

17. The method of claim 1 further a GPS is utilized to indicate the location zone of the viewpoint.

18. A system for augmented reality comprising;
a camera that takes a picture of objects to be displayed in real time on a display;
a conversion program that detects the edges of the objects presented on the display;
a database that stores the 3D model of the objects;
a solver that compares the edges with the database to determine the position and 3D direction of the camera; and
an augmented reality engine that presents a digital content on the display according to the position and 3D direction of the camera.

19. The system of claim 18 further a tracking unit is utilized to detect the movement and rotation of the camera relative to a start position.

20. A method for determining a user's position by analyzing a picture of objects located in front of the user and comparing the picture content with a database that stores a 3D model of the objects to determine the user's position.
